(19) United States
(12) Patent Application Publication
(10) Pub. No.: US 2022/0237421 A1
(43) Pub. Date: Jul. 28, 2022

(54) METHOD FOR OUTPUTTING, COMPUTER-READABLE RECORDING MEDIUM STORING OUTPUT PROGRAM, AND OUTPUT DEVICE

(71) Applicant: FUJITSU LIMITED, Kawasaki-shi (JP)

(72) Inventor: Moyuru YAMADA, Yokohama (JP)

(73) Assignee: FUJITSU LIMITED, Kawasaki-shi (JP)

(21) Appl. No.: 17/719,211

(22) Filed: Apr. 12, 2022

Related U.S. Application Data
(63) Continuation of application No. PCT/JP2019/044770, filed on Nov. 14, 2019.

(51) Int. Cl. G06K 9/62; G06N 20/00

(52) U.S. Cl. CPC G06K 9/6293; G06K 9/6298; G06N 20/00

(57) ABSTRACT

A computer-implemented outputting method including: generating a correction vector that corrects a vector based on information of a first modal on the basis of correlation between the vector based on the information of the first modal and a vector based on information of a second modal; combining the generated correction vector with the vector based on the information of the first modal; compressing the combined vector based on the information of the first modal according to a predetermined rule; performing normalization processing for the compressed vector based on the information of the first modal; and outputting a vector obtained by the normalization processing.

### CROSS-REFERENCE TO RELATED APPLICATION

This application is a continuation application of International Application PCT/JP2019/044770 filed on Nov. 14, 2019 and designated the U.S., the entire contents of which are incorporated herein by reference.

### FIELD

The embodiments discussed herein are related to a method for outputting, an output program, and an output device.

### BACKGROUND

In the past, there has been a technique for solving a problem using information of a plurality of modals. This technique is used to, for example, solve problems such as document translation, question and answer, object detection, and situation determination. Here, the modal is a concept indicating a form or type of information, and specific examples of the modal include an image, a document (text), a voice, and the like. Machine learning using a plurality of modals is called multimodal learning.

As an existing technique, for example, there is a technique called Transformer that transforms information by Attention. For example, Attention calculates a weighted sum of values obtained from a vector based on information of a second modal on the basis of a correlation between a query obtained from a vector based on information of a first modal and a key obtained from the vector based on the information of the second modal, and adds the weighted sum to the vector based on the information of the first modal.

Vaswani, Ashish, et al. “Attention is all you need” Advances in neural information processing systems. 2017 is disclosed as related art.

### SUMMARY

According to an aspect of the embodiments, there is provided a computer-implemented outputting method including: generating a correction vector that corrects a vector based on information of a first modal on the basis of correlation between the vector based on the information of the first modal and a vector based on information of a second modal; combining the generated correction vector with the vector based on the information of the first modal; compressing the combined vector based on the information of the first modal according to a predetermined rule; performing normalization processing for the compressed vector based on the information of the first modal; and outputting a vector obtained by the normalization processing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a method for outputting according to an embodiment;

FIG. 2 is an explanatory diagram illustrating an example of an information processing system 200;

FIG. 3 is a block diagram illustrating a hardware configuration example of an output device 100;

FIG. 4 is a block diagram illustrating a functional configuration example of the output device 100;

FIG. 5 is an explanatory diagram illustrating a specific example of a Co-Attention Network 500;

FIG. 6 is an explanatory diagram illustrating a specific example of an SA layer 600 and a specific example of a TA layer 610;

FIG. 7 is an explanatory diagram illustrating a specific example of an image TA layer 501;

FIG. 8 is an explanatory diagram illustrating another specific example of the image TA layer 501;

FIG. 9 is an explanatory diagram illustrating a comparative example between the image TA layer 501 and a document TA layer 503;

FIG. 10 is an explanatory diagram illustrating an example of operation using a CAN500;

FIG. 11 is an explanatory diagram (No. 1) illustrating a use example 1 of the output device 100;

FIG. 12 is an explanatory diagram (No. 2) illustrating the use example 1 of the output device 100;

FIG. 13 is an explanatory diagram (No. 1) illustrating a use example 2 of the output device 100;

FIG. 14 is an explanatory diagram (No. 2) illustrating the use example 2 of the output device 100;

FIG. 15 is a flowchart illustrating an example of a learning processing procedure;

FIG. 16 is a flowchart illustrating an example of an estimation processing procedure; and

FIG. 17 is a flowchart illustrating an example of an attention processing procedure.

### DESCRIPTION OF EMBODIMENTS

However, in the existing technique, the accuracy of a solution when solving a problem using a plurality of modal information may be poor. For example, in solving a problem of determining a situation on the basis of an image and a document, if the weighted sum of values obtained from a vector based on information of a modal related to the document is simply added to a vector based on information of a modal related to the image by Attention, information useful for solving the problem is likely to be lost. Therefore, accuracy of a solution when solving the problem is likely to be poor.

In one aspect, an object of the present embodiments is to improve accuracy of a solution when solving a problem using information of a plurality of modals.

Hereinafter, embodiments of a method for outputting, an output program, and an output device will be described in detail with reference to the drawings.

### An Example of a Method for Outputting According to an Embodiment

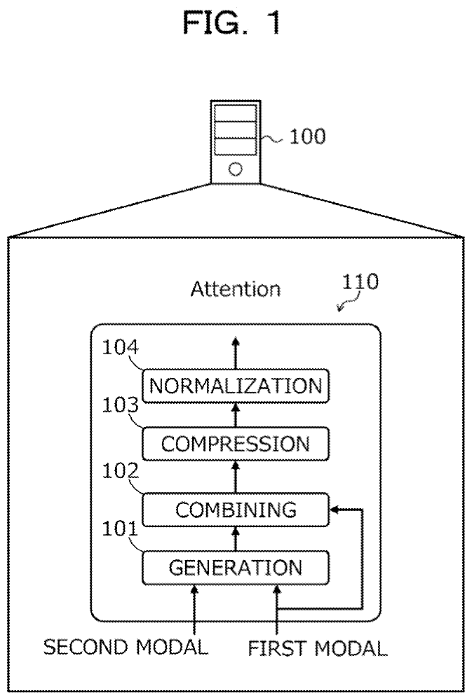

FIG. 1 is an explanatory diagram illustrating an example of a method for outputting according to an embodiment. An output device 100 is a computer for improving accuracy of a solution when solving a problem by making it easy to obtain information useful for solving the problem by using information of a plurality of modals.

In the past, as a method for solving a problem, for example, there has been a method called bidirectional encoder representations from transformers (BERT) using Transformer that transforms information by Attention.

For example, BERT is formed by stacking Encoder parts of Transformer. For BERT, for example, Devlin, Jacob et al. “BERT: Pre-training of Deep Bidirectional Transformers for Language Understanding” NAACL-HLT (2019) can be referred to.

Here, BERT is supposed to be applied to situations where a problem is solved using information of a modal related to a document, and is not able to be applied to situations where a problem is solved using information of a plurality of modals.

Meanwhile, for example, there has been a method called VideoBERT. VideoBERT is, for example, an extension of BERT that can be applied to situations where a problem is solved using information of a modal related to a document and information of a modal related to an image. For VideoBERT, for example, Sun, Chen, et al. “Videobert: A joint model for video and language representation learning” arXiv preprint arXiv:1904.01766 (2019) can be referred to.

Furthermore, there has been a method called modular co-attention network (MCAN), for example. MCAN solves a problem by reference to a vector based on information of a modal related to a document and a vector based on information of a modal related to an image, which is corrected on the basis of the vector based on the information of the modal related to the document. For MCAN, for example, Yu, Zhou, et al. “Deep Modular Co-Attention Networks for Visual Question Answering” Proceedings of the IEEE Conference on Computer Vision and Pattern Recognition. 2019 can be referred to.

Furthermore, there is a method called vision-and-language bidirectional encoder representations from transformers (ViLBERT), for example. ViLBERT is a technique for solving a problem by reference to a vector based on information of a modal related to a document, which is corrected on the basis of a vector based on information of a modal related to an image, and a vector based on the information of a modal related to an image, which is corrected on the basis of the vector based on the information of a modal related to a document.

Lu, Jiasen, et al. “vilbert: Pretraining task-agnostic visiolinguistic representations for vision-and-language tasks” arXiv preprint arXiv:1908.02265 (2019) is disclosed as related art.

However, even with the above-described methods such as VideoBERT, MCAN, and ViLBERT, the accuracy of the solution when solving a problem using a plurality of modal information may be poor. For example, by any method, since a weighted sum of values obtained from a vector based on information of a modal related to a document is simply added to a vector based on information of a modal related to an image by Attention, there is a property that information useful for solving a problem is likely to be lost. Therefore, by any method, the accuracy of the solution when solving the problem is likely to be poor. Furthermore, since VideoBERT handles the information of a modal related to a document and the information of a modal related to an image without explicitly distinguishing them when solving a problem, the accuracy of the solution when solving the problem is poor.

Therefore, in the present embodiment, a method for outputting that may be applied to a situation of solving a problem using information of a plurality of modals by enabling generation of a vector useful in solving the problem, and may make the accuracy of the solution when solving the problem improvable will be described.

In FIG. 1, the output device 100 has, for example, a transformation model 110 that implements Attention. The transformation model includes a generation model 101, a combining model 102, a compression model 103, and a normalization model 104.

The output device 100 acquires the vector based on the information of the first modal and the vector based on the information of the second modal. The modal means a form of information. The first modal and the second modal are modals different from each other. The first modal is, for example, a modal related to an image. The second modal is, for example, a modal related to a document.

The vector based on the information of the first modal is a vector represented according to the first modal, for example. The vector based on the information of the first modal is generated on the basis of, for example, the information of the first modal. The information of the first modal is, for example, an image. The vector based on the information of the first modal is, for example, a vector generated on the basis of the image.

The vector based on the information of the second modal is a vector represented according to the second modal, for example. The vector based on the information of the second modal is generated on the basis of, for example, the information of the second modal. The information of the second modal is, for example, a document. The vector based on the information of the second modal is, for example, a vector generated on the basis of the document.

(1-1) The output device 100 generates a correction vector for correcting the vector based on the information of the first modal on the basis of a correlation between the vector based on the information of the first modal and the vector based on the information of the second modal. The output device 100 generates the correction vector for correcting the vector based on the information of the first modal by using, for example, a generation model 101.

The correlation is expressed by, for example, by a degree of similarity between a vector obtained from the vector based on the information of the first modal and a vector obtained from the vector based on the information of the second modal. The vector obtained from the vector based on the information of the first modal is, for example, a query. The vector obtained from the vector based on the information of the second modal is, for example, a key. The degree of similarity is expressed by, for example, an inner product. The degree of similarity may also be expressed by, for example, a sum of squares of differences, or the like.

(1-2) The output device 100 combines the generated correction vector with the vector based on the information of the first modal. The output device 100 combines the generated correction vector with the vector based on the information of the first modal, using, for example, the combining model 102.

(1-3) The output device 100 compresses the combined vector based on the information of the first modal according to a predetermined rule. The output device 100 compresses the combined vector based on the information of the first modal, using, for example, the compression model 103. The compression involves transformations that do not reduce the number of dimensions.

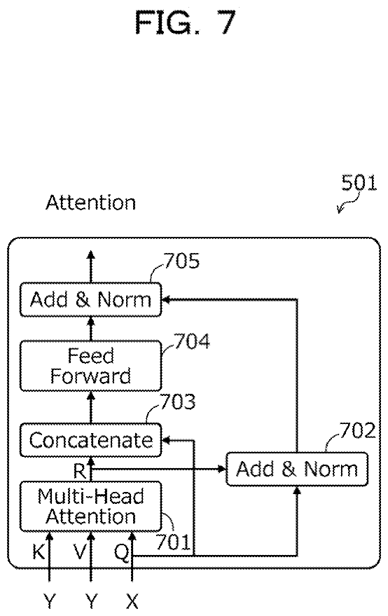

(1-4) The output device 100 performs normalization processing for the compressed vector based on the information of the first modal. The output device 100 performs the normalization processing using, for example, the normalization model 104. A specific example of performing the normalization processing will be described below with reference to, for example, FIG. 7.

(1-5) The output device 100 outputs the vector obtained by the normalization processing. An output format is, for example, display on a display, print output to a printer, transmission to another computer, storage in a storage area, or the like. Thereby, the output device 100 may generate a vector having a tendency of reflecting information useful for solving a problem in the vector based on the information of the first modal and the vector based on the information of the second modal, and may make the generated vector available. As a result, the output device 100 may improve the accuracy of a subsequent solution when solving a problem.

Here, for example, in a case where the first modal is related to an image and the second modal is related to a document, it may be considered that the second modal has a feature that it belongs to a higher hierarchy than the first modal. For example, “apple (word)” is a concept that includes a plurality of “apples (images)”.

The output device 100 may use this feature, and combine the correction vector based on the vector based on the information of the second modal related to the document with the vector based on the information of the first modal related to the image and then compress the combined vector. Therefore, the output device 100 may make the information useful for solving the problem in the image and the document difficult to lose and easy to reflect in the compressed vector. The output device 100 may make the compressed vector available, which effectively represents, on a computer, the feature useful for solving the problem in the features of the image and the document in a real world, for example. As a result, the output device 100 may obtain a useful vector in solving the problem using the information of a plurality of modals, and may make the accuracy of the solution when solving the problem improvable.

Here, a case in which the first modal and the second modal are modals different from each other has been described. However, the embodiment is not limited to the case. For example, the first modal and the second modal may also be the same modal.

### One Example of Information Processing System 200

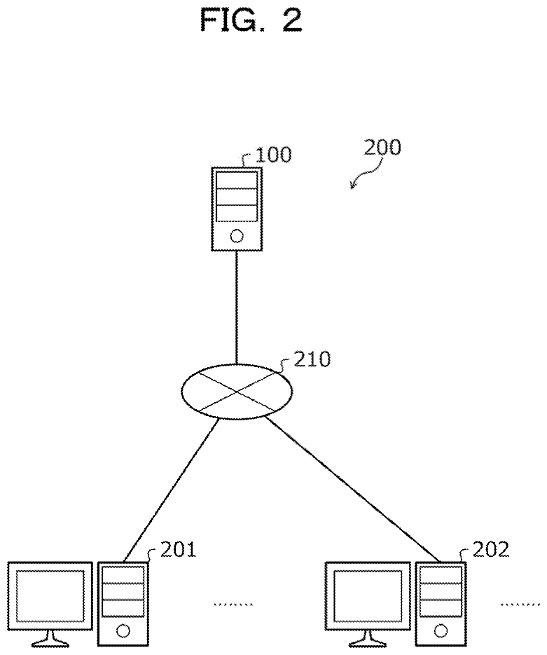

Next, one example of an information processing system 200 to which the output device 100 illustrated in FIG. 1 is applied will be described with reference to FIG. 2.

FIG. 2 is an explanatory diagram illustrating an example of the information processing system 200. In FIG. 2, the information processing system 200 includes the output device 100, a client device 201, and a terminal device 202.

In the information processing system 200, the output device 100 and the client devices 201 are connected via a wired or wireless network 210. The network 210 is, for example, a local area network (LAN), a wide area network (WAN), the Internet, or the like. Furthermore, in the information processing system 200, the output device 100 and the terminal devices 202 are connected via the wired or wireless network 210.

The output device 100 has a Co-Attention Network that generates an integrated vector in which the vector based on the information of the first modal and the vector based on the information of the second modal are integrated on the basis of the vector based on the information of the first modal and the vector based on the information of the second modal. The first modal is, for example, a modal related to an image. The second modal is, for example, a modal related to a document. The Co-Attention Network is formed using, for example, the transformation model 110 illustrated in FIG. 1.

The output device 100 updates the Co-Attention Network on the basis of training data. The training data is, for example, correspondence information in which information of the first modal serving as a source for generating the vector based on the information of the first modal as a sample, information of the second modal serving as a source for generating the vector based on the information of the second modal as a sample, and correct answer data are associated with one another. The training data is input to the output device 100 by the user of the output device 100, for example. The correct answer data shows, for example, a correct answer of a case where a problem is solved. For example, when the first modal is a modal related to an image, the information in the first modal is the image. For example, when the second modal is a modal related to a document, the information in the second modal is the document.

The output device 100 acquires the vector based on the information of the first modal by generating the vector from the image of the training data serving as the information of the first modal, and acquires the vector based on the information of the second modal by generating the vector from the document of the training data serving as the information of the second modal, for example. Then, the output device 100 updates the Co-Attention Network by error back propagation or the like on the basis of the acquired vector based on the information of the first modal, the acquired vector based on the information of the second modal, and the correct answer data of the training data. The output device 100 may also update the Co-Attention Network by a learning method other than error back propagation.

The output device 100 acquires the vector based on the information of the first modal and the vector based on the information of the second modal. Then, the output device 100 generates the integrated vector on the basis of the acquired vector based on the information of the first modal and the acquired vector based on the information of the second modal, using the Co-Attention Network, and solves a problem on the basis of the generated integrated vector. Thereafter, the output device 100 transmits the result of solving the problem to the client device 201.

The output device 100 acquires, for example, the vector based on the information of the first modal input to the output device 100 by the user of the output device 100. Furthermore, the output device 100 may also acquire the vector based on the information of the first modal by receiving the vector from the client device 201 or the terminal device 202. Furthermore, the output device 100 may also receive the information of the first modal from the client device 201 or the terminal device 202, and acquire the vector based on the information of the first modal by generating the vector from the received information of the first modal, for example.

The output device 100 acquires, for example, the vector based on the information of the second modal input to the output device 100 by the user of the output device 100. Furthermore, the output device 100 may also acquire the vector based on the information of the second modal by receiving the vector from the client device 201 or the terminal device 202. Furthermore, the output device 100 may also receive the information of the second modal from the client device 201 or the terminal device 202, and acquire the vector based on the information of the second modal by generating the vector from the received information of the second modal, for example.

Then, the output device 100 generates the integrated vector on the basis of the acquired vector based on the information of the first modal and the acquired vector based on the information of the second modal, using the Co-Attention Network, and solves a problem on the basis of the generated integrated vector. Thereafter, the output device 100 transmits the result of solving the problem to the client device 201. The output device 100 is, for example, a server, a personal computer (PC), or the like.

The client device 201 is a computer capable of communicating with the output device 100. The client device 201 may also transmit, for example, the vector based on the information of the first modal to the output device 100. Furthermore, the client device 201 may also transmit, for example, the information of the first modal to the output device 100. The client device 201 may also transmit, for example, the vector based on the information of the second modal to the output device 100. Furthermore, the client device 201 may also transmit, for example, the information of the second modal to the output device 100.

The client device 201 receives and outputs the result of solving the problem by the output device 100. An output format is, for example, display on a display, print output to a printer, transmission to another computer, storage in a storage area, or the like. The client device 201 is, for example, a PC, a tablet terminal, a smartphone, or the like.

The terminal device 202 is a computer capable of communicating with the output device 100. The terminal device 202 may also transmit, for example, the vector based on the information of the first modal to the output device 100. Furthermore, the terminal device 202 may also transmit, for example, the information of the first modal to the output device 100. The terminal device 202 may also transmit, for example, the vector based on the information of the second modal to the output device 100. Furthermore, the terminal device 202 may also transmit, for example, the information of the second modal to the output device 100. The terminal device 202 is, for example, a PC, a tablet terminal, a smartphone, an electronic device, an Internet of Things (IoT) device, a sensor device, or the like. For example, the terminal device 202 may also be a surveillance camera.

Here, a case in which the output device 100 updates the Co-Attention Network and solves a problem using the Co-Attention Network has been described. However, the embodiment is not limited to the case. For example, there may also be a case where another computer updates the Co-Attention Network, and the output device 100 solves a problem using the Co-Attention Network received from the another computer. Furthermore, for example, there may also be a case where the output device 100 updates the Co-Attention Network and provides the Co-Attention Network to another computer, and the another computer solves a problem using the Co-Attention Network.

Here, a case in which the training data is the correspondence information in which information of the first modal serving as a source for generating the vector based on the information of the first modal, information of the second modal serving as a source for generating the vector based on the information of the second modal, and correct answer data are associated with one another has been described. However, the embodiment is not limited to the case. For example, the training data may also be correspondence information in which the vector based on the information of the first modal serving as a sample, the vector based on the information of the second modal serving as a sample, and the correct answer data are associated with one another.

Here, a case in which the output device 100 is a different device from the client device 201 and the terminal device 202 has been described. However, the embodiment is not limited to the case. For example, there may also be a case in which the output device 100 is integrated with the client device 201. Furthermore, for example, there may also be a case in which the output device 100 is integrated with the terminal device 202.

Here, a case in which the output device 100 implements the Co-Attention Network in terms of software has been described. However, the present embodiment is not limited to the case. For example, there may also be a case where the output device 100 implements the Co-Attention Network in terms of an electronic circuit.

### Application Example 1 of Information Processing System 200

In application example 1, the output device 100 stores an image and a document that serves as a question sentence about the image. The question sentence is, for example, “what is cut in the image”. Then, the output device 100 solves a problem of estimating an answer sentence to the question sentence on the basis of the image and the document. The output device 100 estimates the answer sentence to the question sentence about what is cut in the image on the basis of the image and the document, for example, and transmits the answer sentence to the client device 201.

### Application Example 2 of Information Processing System 200

In application example 2, the terminal device 202 is a surveillance camera, and transmits an image in which an object is captured to the output device 100. The object is, for example, an appearance of a fitting room. Furthermore, the output device 100 stores a document that serves as an explanatory text about the object. For example, the explanatory text is an explanatory text that a curtain of the fitting room tends to be closed while a human is using the fitting room. Then, the output device 100 solves a problem of determining a degree of risk on the basis of the image and the document. The degree of risk is, for example, an index value indicating a level of a possibility that a human who has not completed evacuation remains in the fitting room. The output device 100 determines, for example, the degree of risk indicating a level of a possibility that a human who has not completed evacuation remains in the fitting room in an event of a disaster.

### Application Example 3 of Information Processing System 200

In application example 3, the output device 100 stores an image forming a moving image and a document serving as an explanatory text about the image. The moving image is, for example, a moving image capturing a state of cooking. The explanatory text is, for example, an explanatory text about a cooking procedure. Then, the output device 100 solves a problem of determining a degree of risk on the basis of the image and the document. The degree of risk is, for example, an index value indicating a level of risk during cooking. The output device 100 determines the degree of risk indicating a level of risk during cooking for example.

### Hardware Configuration Example of Output Device 100

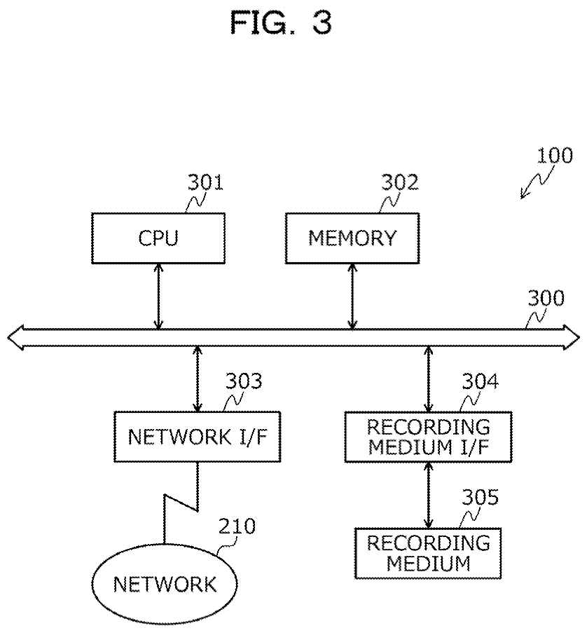

Next, a hardware configuration example of the output device 100 will be described with reference to FIG. 3.

FIG. 3 is a block diagram illustrating a hardware configuration example of the output device 100. In FIG. 3, the output device 100 has a central processing unit (CPU) 301, a memory 302, a network interface (I/F) 303, a recording medium I/F 304, and a recording medium 305. Furthermore, the individual configuration units are connected to each other by a bus 300.

Here, the CPU 301 controls the entire output device 100. The memory 302 includes, for example, a read only memory (ROM), a random access memory (RAM), a flash ROM, and the like. For example, the flash ROM or the ROM stores various programs, and the RAM is used as a work area for the CPU 301. A program stored in the memory 302 is loaded into the CPU 301 to cause the CPU 301 to execute coded processing.

The network I/F 303 is connected to the network 210 through a communication line, and is connected to another computer through the network 210. Then, the network I/F 303 manages an interface between the network 210 and the inside and controls input and output of data to and from the another computer. Examples of the network I/F 303 include a modem, a LAN adapter, and the like.

The recording medium I/F 304 controls read and write of data to and from the recording medium 305 under the control of the CPU 301. For example, the recording medium I/F 304 is a disk drive, a solid state drive (SSD), a universal serial bus (USB) port, or the like. The recording medium 305 is a nonvolatile memory that stores data written under the control of the recording medium I/F 304. The recording medium 305 includes, for example, a disk, a semiconductor memory, a USB memory, and the like. The recording medium 305 may also be attachable to and detachable from the output device 100.

The output device 100 may also include, for example, a keyboard, a mouse, a display, a printer, a scanner, a microphone, a speaker, or the like in addition to the above-described configuration units. Furthermore, the output device 100 may also include a plurality of the recording medium I/Fs 304 and the recording media 305. Furthermore, the output device 100 does not need to include the recording medium I/F 304 and the recording medium 305.

### Hardware Configuration Example of Client Device 201

Since the hardware configuration example of the client device 201 is, for example, similar to the hardware configuration example of the output device 100 illustrated in FIG. 3, description thereof is omitted.

### Hardware Configuration Example of Terminal Device 202

Since the hardware configuration example of the terminal device 202 is, for example, similar to the hardware configuration example of the output device 100 illustrated in FIG. 3, description thereof is omitted.

### Functional Configuration Example of Output Device 100

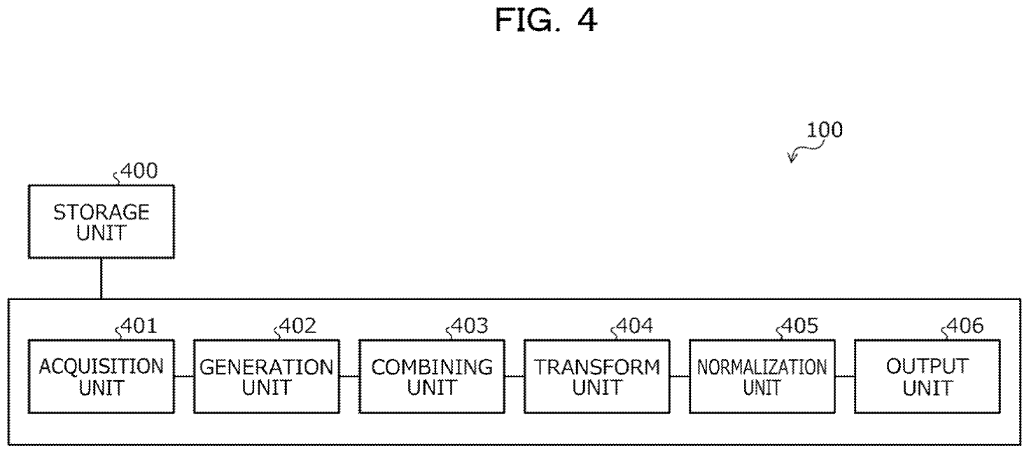

Next, a functional configuration example of the output device 100 will be described with reference to FIG. 4.

FIG. 4 is a block diagram illustrating a functional configuration example of the output device 100. The output device 100 includes a storage unit 400, an acquisition unit 401, a generation unit 402, a combining unit 403, a transform unit 404, a normalization unit 405, and an output unit 406.

The storage unit 400 is implemented by a storage area such as the memory 302, the recording medium 305, or the like illustrated in FIG. 3, for example. Hereinafter, a case in which the storage unit 400 is included in the output device 100 will be described. However, the present embodiment is not limited to the case. For example, there may also be a case where the storage unit 400 is included in a device different from the output device 100, and stored content in the storage unit 400 is able to be referred to by the output device 100.

The acquisition unit 401 to the output unit 406 function as an example of a control unit. For example, the acquisition unit 401 to the output unit 406 implement functions thereof by causing the CPU 301 to execute a program stored in the storage area of the memory 302, the recording medium 305, or the like or by the network I/F 303 illustrated in FIG. 3. A processing result of each functional unit is stored in the storage area such as the memory 302 or the recording medium 305 illustrated in FIG. 3, for example.

The storage unit 400 stores various types of information to be referred to or updated in the processing of each functional unit. The storage unit 400 stores a transformation model that implements Attention, corrects the vector based on the information of the first modal, on the basis of the vector based on the information of the second modal, and outputs the corrected vector based on the information of the first modal.

For example, the first modal is a modal related to an image, and the second modal is a modal related to a document. For example, the first modal is a modal related to an image, and the second modal is a modal related to a voice. For example, the first modal is a modal related to a document in a first language, and the second modal is a modal related to a document in a second language. For example, the first modal may also be the same as the second modal.

The acquisition unit 401 acquires various types of information to be used for processing of each functional unit. The acquisition unit 401 stores the acquired various types of information in the storage unit 400 or outputs the acquired various types of information to each functional unit. Furthermore, the acquisition unit 401 may also output the various types of information stored in the storage unit 400 to each functional unit. The acquisition unit 401 acquires the various types of information on the basis of, for example, an operation input by the user. The acquisition unit 401 may also receive the various types of information from a device different from the output device 100, for example.

The acquisition unit 401 acquires the vector based on the information of the first modal and the vector based on the information of the second modal. For example, the acquisition unit 401 accepts input by the user of the information of the first modal serving as a source for generating the vector based on the information of the first modal and the information of the second modal serving as a source for generating the vector based on the information of the second modal. Then, the acquisition unit 401 generates the vector based on the information of the first modal and the vector based on the information of the second modal on the basis of the input various types of information.

For example, the acquisition unit 401 acquires an image as the information of the first modal and generates a feature amount vector related to the acquired image as the vector based on the information of the first modal. The feature amount vector related to the image is, for example, an arrangement of the feature amount vectors of respective objects captured in the image. Furthermore, for example, the acquisition unit 401 acquires a document as the information of the second modal, and generates a feature amount vector related to the acquired document as the vector based on the information of the second modal. The feature amount vector related to the document is, for example, an arrangement of the feature amount vectors of respective words contained in the document.

For example, the acquisition unit 401 may also receive the information of the first modal serving as a source for generating the vector based on the information of the first modal and the information of the second modal serving as a source for generating the vector based on the information of the second modal, from the client device 201 or the terminal device 202. Then, the acquisition unit 401 generates the vector based on the information of the first modal and the vector based on the information of the second modal on the basis of the acquired various types of information.

For example, the acquisition unit 401 acquires an image as the information of the first modal and generates a feature amount vector related to the acquired image as the vector based on the information of the first modal. The feature amount vector related to the image is, for example, an arrangement of the feature amount vectors of respective objects captured in the image. Furthermore, for example, the acquisition unit 401 acquires a document as the information of the second modal, and generates a feature amount vector related to the acquired document as the vector based on the information of the second modal. The feature amount vector related to the document is, for example, an arrangement of the feature amount vectors of respective words contained in the document.

The acquisition unit 401 may also acquire the vector based on the information of the first modal and the vector based on the information of the second modal by accepting input by the user of the vector based on the information of the first modal and the vector based on the information of the second modal, for example. For example, the acquisition unit 401 may also acquire the vector based on the information of the first modal and the vector based on the information of the second modal by receiving the vectors from the client device 201 or the terminal device 202.

The acquisition unit 401 may also accept a start trigger to start the processing of any one of the functional units. The start trigger is, for example, a predetermined operation input made by the user. The start trigger may also be, for example, the receipt of predetermined information from another computer. The start trigger may also be, for example, output of predetermined information by any one of the functional units. For example, the acquisition unit 401 accepts the acquisition of the vector based on the information of the first modal and the vector based on the information of the second modal as the start trigger to start the processing of each functional unit.

The generation unit 402 generates a correction vector for correcting the vector based on the information of the first modal on the basis of a correlation between the vector based on the information of the first modal and the vector based on the information of the second modal. The correlation is expressed by, for example, by a degree of similarity between a vector obtained from the vector based on the information of the first modal and a vector obtained from the vector based on the information of the second modal. The vector obtained from the vector based on the information of the first modal is, for example, a query. The vector obtained from the vector based on the information of the second modal is, for example, a key. The degree of similarity is expressed by, for example, an inner product. The degree of similarity may also be expressed by, for example, a sum of squares of differences, or the like.

The generation unit 402 generates the correction vector on the basis of an inner product of a vector obtained from the vector based on the information of the first modal and a vector obtained from the vector based on the information of the second modal, for example. For example, the generation unit 402 generates the correction vector for correcting the vector based on the information of the first modal on the basis of the inner product of the query obtained from the vector based on the information of the first modal and the key obtained from the vector based on the information of the second modal.

More specifically, the generation unit 402 generates the correction vector for correcting a vector based on the information of the modal related to an image on the basis of an inner product of a query obtained from a vector based on the information of the modal related to an image and a key obtained from a vector based on the information of the modal related to a document. Here, an example of generating the correction vector is illustrated in, for example, an operation example to be described below with reference to FIG. 7. As a result, the generation unit 402 may generate the correction vector capable of correcting the vector based on the information of the first modal so that a component relatively closely related to the vector based on the information of the first modal, in the vector based on the information of the second modal, is strongly reflected in the vector based on the information of the first modal.

The combining unit 403 combines the generated correction vector with the vector based on the information of the first modal. For example, the combining unit 403 does not add the correction vector to the vector based on the information of the first modal and combines the correction vector to either before or after the first modal. Thereby, the combining unit 403 may process the vector based on the information of the first modal such that the information useful for solving a problem in the vector based on the information of the first modal and the vector based on the information of the second modal is difficult to lose and easy to reflect.

The transform unit 404 compresses the combined vector based on the information of the first modal according to a predetermined rule. The predetermined rule is automatically set by learning, for example. The transform unit 404 compresses the combined vector based on the information of the first modal using a multi-layer neural network, for example. Thereby, the transform unit 404 may transform the number of dimensions of the combined vector based on the information of the first modal into the number of dimensions that is easy to handle.

The normalization unit 405 performs normalization processing for the compressed vector based on the information of the first modal. The normalization unit 405 normalizes a sum of the vector based on the information of the first modal and the correction vector, and normalizes a sum of a vector obtained by the corresponding normalization and the compressed vector based on the information of the first modal, for example. Thereby, the normalization unit 405 may obtain the vector useful for solving a problem, in which the information useful for solving a problem in the vector based on the information of the first modal and the vector based on the information of the second modal is efficiently reflected.

The normalization unit 405 normalizes a sum of the combined vector based on the information of the first modal and the compressed vector based on the information of the first modal, for example. Thereby, the normalization unit 405 may obtain the vector useful for solving a problem, in which the information useful for solving a problem in the vector based on the information of the first modal and the vector based on the information of the second modal is efficiently reflected.

The output unit 406 outputs a processing result of one of the functional units. An output format is, for example, display on a display, print output to a printer, transmission to an external device by the network I/F 303, or storage in the storage area such as the memory 302 or the recording medium 305. Thereby, the output unit 406 makes it possible to notify the user of the processing result of each functional unit, and may aim for improvement of convenience of the output device 100.

The output unit 406 outputs the vector obtained by the normalization processing. Thereby, the output unit 406 may implement Attention by using the vector obtained by the normalization processing. Then, the output unit 406 may implement the Co-Attention Network by Attention.

The output unit 406 may output the vector obtained by the normalization processing, for example, by Attention, which is useful for solving a problem. Therefore, the output unit 406 may make the Co-Attention Network learnable so as to be useful for solving the problem. Furthermore, the output unit 406 may make the accuracy of the solution when solving the problem improvable.

### Operation Example of Output Device 100

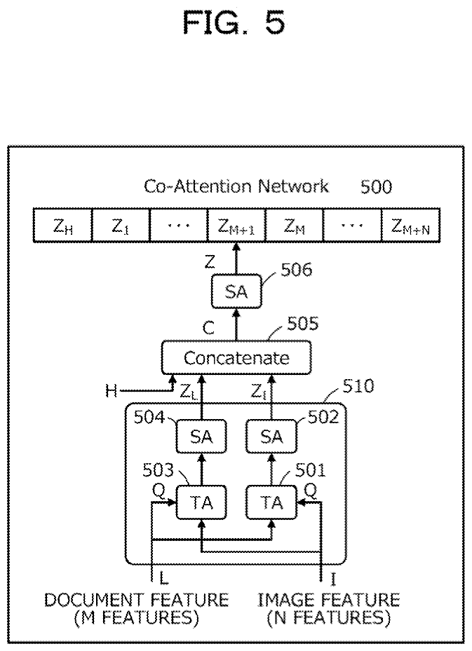

Next, an operation example of the output device 100 will be described with reference to FIGS. 5 to 7. First, a specific example of a Co-Attention Network 500 used by the output device 100 will be described with reference to FIG. 5.

FIG. 5 is an explanatory diagram illustrating a specific example of the Co-Attention Network 500. In the following description, the Co-Attention Network 500 may be referred to as “CAN500”. Furthermore, the target-attention may be expressed as “TA”. Furthermore, self-attention may be referred to as “SA”.

As illustrated in FIG. 5, the CAN500 has an image TA layer 501, an image SA layer 502, a document TA layer 503, a document SA layer 504, a combining layer 505, and an integrated SA layer 506.

In FIG. 5, the CAN500 outputs a vector Z_{T} in response to input of a feature amount vector L related to a document and a feature amount vector I related to an image. The feature amount vector L related to a document is, for example, an arrangement of M feature amount vectors related to the document. The M feature amount vectors are, for example, the feature amount vectors representing M words contained in the document. The feature amount vector I related to the image is, for example, an arrangement of N feature amount vectors related to the image. The N feature amount vectors are, for example, the feature amount vector representing N objects captured in the image.

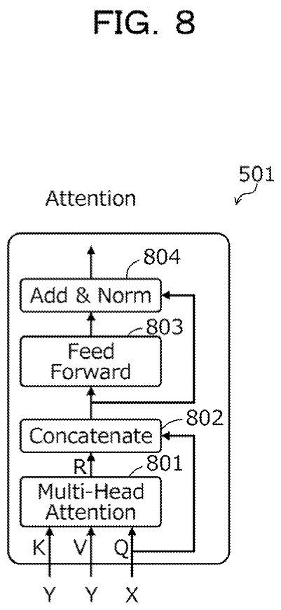

For example, the image TA layer 501 accepts input of the feature amount vector I related to the image and the feature amount vector L related to the document. The image TA layer 501 corrects the feature amount vector I for the image on the basis of a query obtained from the feature amount vector I related to the image and a key and a value obtained from the feature amount vector L related to the document. The image TA layer 501 outputs the corrected feature amount vector I related to the image to the image SA layer 502. A specific example of the image TA layer 501 will be described below with reference to, for example, FIGS. 7 and 8.

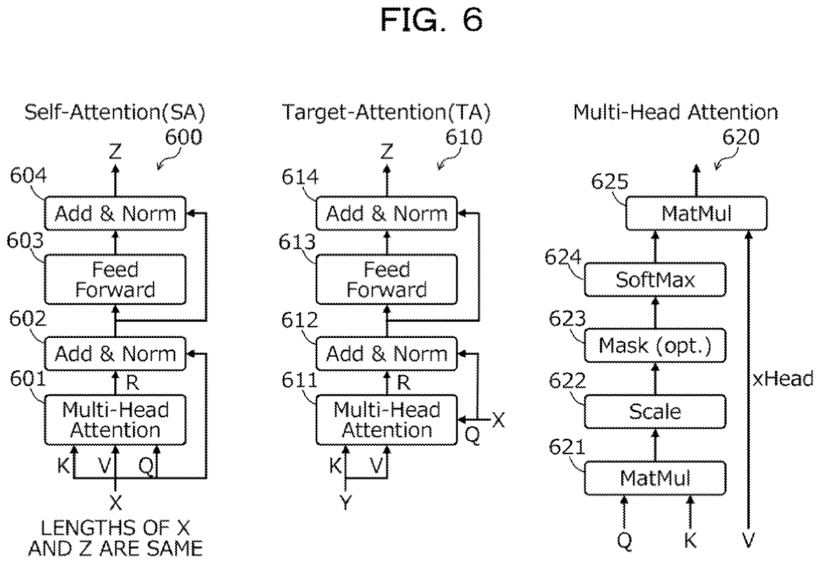

Furthermore, the image SA layer 502 accepts input of the corrected feature amount vector I related to the image. The image SA layer 502 further corrects the corrected feature amount vector I related to the image on the basis of a query, a key, and a value obtained from the corrected feature amount vector I related to the image, generates a new feature amount vector Z_{I}, and outputs the new feature amount vector Z_{I} to the combining layer 505. A specific example of the SA layer that implements the image SA layer 502 will be described below with reference to, for example, FIG. 6.

Furthermore, the document TA layer 503 accepts input of the feature amount vector L related to the document and the feature amount vector I related to the image. The document TA layer 503 corrects the feature amount vector L related to the document on the basis of the query obtained from the feature amount vector L related to the document and the key and value obtained from the feature amount vector I related to the image. The document TA layer 503 outputs the corrected feature amount vector L related to the document to the document SA layer 504. A specific example of the TA layer that implements the document TA layer 503 will be described below with reference to, for example, FIG. 6.

Furthermore, the document SA layer 504 accepts input of the corrected feature amount vector L related to the document. The document SA layer 504 further corrects the corrected feature amount vector L related to the document on the basis of the query, key, and value obtained from the corrected feature amount vector L related to the document, and generates and outputs a new feature amount vector Z_{L}. A specific example of the SA layer that implements the document SA layer 504 will be described below with reference to, for example, FIG. 6.

Furthermore, the combining layer 505 receives input of a vector for aggregation H, the feature amount vector Z_{I}, and the feature amount vector Z_{L}. The combining layer 505 combines the vector for aggregation H, the feature amount vector Z_{I}, and the feature amount vector Z_{L} to generate a combined vector C, and outputs the combined vector C to the integrated SA layer 506.

Furthermore, the integrated SA layer 506 accepts input of the combined vector C. The integrated SA layer 506 corrects the combined vector C on the basis of a query, a key, and a value obtained from the combined vector C, and generates and outputs a feature amount vector Z_{T}. The feature amount vector Z_{T} includes an aggregate vector Z_{H}, integrated feature amount vectors Z₁ to Z_{M} related to the document, and integrated feature amount vectors Z_{M+1} to Z_{M+N} related to the image. Thereby, the output device 100 may generate the feature amount vector Z_{T} including the aggregate vector Z_{H} that is useful in terms of improving the accuracy of the solution when solving a problem, and make the feature amount vector Z_{T} referenceable. Therefore, the output device 100 may make the accuracy of the solution when solving a problem improvable.

Here, for simplification of description, a case in which a group 510 of the image TA layer 501, the image SA layer 502, the document TA layer 503, and the document SA layer 504 has one stage has been described. However, the embodiment is not limited to the case. For example, there may also be a case where the group 510 of the image TA layer 501, the image SA layer 502, the document TA layer 503, and the document SA layer 504 exists in a plurality of stages. According to this, the output device 100 may aim for further improvement of the accuracy of the solution when the problem is solved.

Here, a case in which the CAN500 has the image TA layer 501, the image SA layer 502, the document TA layer 503, the document SA layer 504, the combining layer 505, and the integrated SA layer 506 has been described. However, the embodiment is not limited to the case. For example, there may also be a case where the CAN500 does not have the combining layer 505 and the integrated SA layer 506. In this case, the output device 100 uses, for example, output of the image SA layer 502 and output of the document SA layer 504 in solving the problem.

Next, description will move onto FIG. 6, and a specific example of the SA layer 600 that implements the image SA layer 502, the document SA layer 504, the integrated SA layer 506, and the like forming the CAN500, and a specific example of the TA layer 610 that implements the document TA layer 503 and the like forming the CAN500 will be described. A specific example of the image TA layer 501 forming the CAN500 will be described below with reference to FIG. 7.

FIG. 6 is an explanatory diagram illustrating a specific example of the SA layer 600 and a specific example of the TA layer 610. In the following description, Multi-Head Attention may be referred to as “MHA”. Furthermore, Add&Norm may be referred to as “A&N”. Furthermore, Feed Forward may be described as “FF”.

As illustrated in FIG. 6, the SA layer 600 has an MHA layer 601, an A&N layer 602, an FF layer 603, and an A&N layer 604. The MHA layer 601 generates a correction vector R that corrects an input vector X on the basis of a query Q, a key K, and a value V obtained from the input vector X, and outputs the correction vector R to the A&N layer 602. For example, the MHA layer 601 divides the input vector X into Head vectors for processing. Head is a natural number greater than or equal to 1.

The A&N layer 602 adds the input vector X and the correction vector R and then normalizes the added vector, and outputs the normalized vector to the FF layer 603 and the A&N layer 604. The FF layer 603 compresses the normalized vector and outputs the compressed vector to the A&N layer 604. The A&N layer 604 adds the normalized vector and the compressed vector, then normalizes the added vector, and generates and outputs an output vector Z.

Furthermore, the TA layer 610 has an MHA layer 611, an A&N layer 612, an FF layer 613, and an A&N layer 614. The MHA layer 611 generates a correction vector R that corrects an input vector X on the basis of the query Q obtained from the input vector X, and the key K and the value V obtained from an input vector Y, and outputs the correction vector R to the A&N layer 612. The A&N layer 612 adds the input vector X and the correction vector R and then normalizes the added vector, and outputs the normalized vector to the FF layer 613 and the A&N layer 614. The FF layer 613 compresses the normalized vector and outputs the compressed vector to the A&N layer 614. The A&N layer 614 adds the normalized vector and the compressed vector, then normalizes the added vector, and generates and outputs the output vector Z.

More specifically, the above-described MHA layer 601 and MHA layer 611 are formed by Head numbers of Attention layers 620. The Attention layer 620 has a MatMul layer 621, a Scale layer 622, a Mask layer 623, a SoftMax layer 624, and a MatMul layer 625.

The MatMul layer 621 calculates the inner product of the query Q and the key K and sets the inner product in Score. The Scale layer 622 divides the entire Score by a constant a and updates the Score. The Mask layer 623 may also mask the updated Score. The SoftMax layer 624 normalizes the updated Score and sets the Score to Att. The MatMul layer 625 calculates the inner product of Att and the value V and sets the inner product in the correction vector R. Next, a specific example of the image TA layer 501 forming the CAN500 will be described with reference to FIGS. 7 and 8.

FIG. 7 is an explanatory diagram illustrating a specific example of the image TA layer 501. In FIG. 7, the image TA layer 501 includes an MHA layer 701, an A&N layer 702, a Con layer 703, an FF layer 704, and an A&N layer 705. The MHA layer 701 generates a correction vector R that corrects an input vector X on the basis of the query Q obtained from the input vector X, and the key K and the value V obtained from an input vector Y, and outputs the correction vector R to the A&N layer 702 and the Con layer 703. The A&N layer 702 adds the input vector X and the correction vector R and then normalizes the added vector, and outputs the normalized vector to the A&N layer 705.

The Con layer 703 combines the input vector X and the correction vector R, and outputs the combined vector to the FF layer 704. The FF layer 704 compresses the combined vector and outputs the compressed vector to the A&N layer 705. The A&N layer 705 adds the normalized vector and the compressed vector, then normalizes the added vector, and outputs the output vector obtained by the normalization. Next, another specific example of the image TA layer 501 will be described with reference to FIG. 8.

FIG. 8 is an explanatory diagram illustrating another specific example of the image TA layer 501. In FIG. 8, the image TA layer 501 includes an MHA layer 801, a Con layer 802, an FF layer 803, and an A&N layer 804. The MHA layer 801 generates a correction vector R that corrects an input vector X on the basis of the query Q obtained from the input vector X, and the key K and the value V obtained from an input vector Y, and outputs the correction vector R to the Con layer 802.

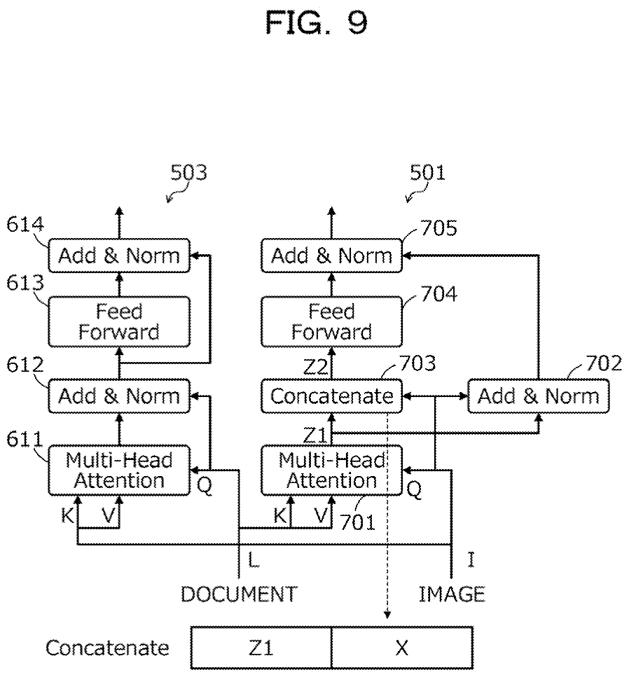

The Con layer 802 combines the input vector X and the correction vector R, and outputs the combined vector to the FF layer 803 and the A&N layer 804. The FF layer 803 compresses the combined vector and outputs the compressed vector to the A&N layer 804. The A&N layer 804 adds the combined vector and the compressed vector, then normalizes the added vector, and outputs the output vector obtained by the normalization. Next, a comparative example between the image TA layer 501 and the document TA layer 503 will be described with reference to FIG. 9.

FIG. 9 is an explanatory diagram illustrating a comparative example between the image TA layer 501 and the document TA layer 503. As illustrated in FIG. 9, the image TA layer 501 and the document TA layer 503 accept input of the feature amount vector L related to the document and the feature amount vector I related to the image. However, the image TA layer 501 and the document TA layer 503 handle the feature amount vector L related to the document and the feature amount vector I related to the image by different methods, respectively.

For example, the image TA layer 501 generates a new feature amount vector Z_{I2} by combining a vector Z_{I1} with the feature amount vector I related to the image. Meanwhile, the document TA layer 503 generates a new feature amount vector Z_{L2} by adding the vector Z_{L1} to the feature amount vector L related to the document. Thereby, the output device 100 may differently handle the feature amount vector L related to the document and the feature amount vector I related to the image, which have different properties from each other.

Then, the output device 100 may make the information useful for solving the problem in the feature amount vector L related to the document and the feature amount vector I related to the image difficult to lose in the image TA layer 501. As a result, the output device 100 may obtain a useful vector in solving the problem using the information of a plurality of modals, and may make the accuracy of the solution when solving the problem improvable.

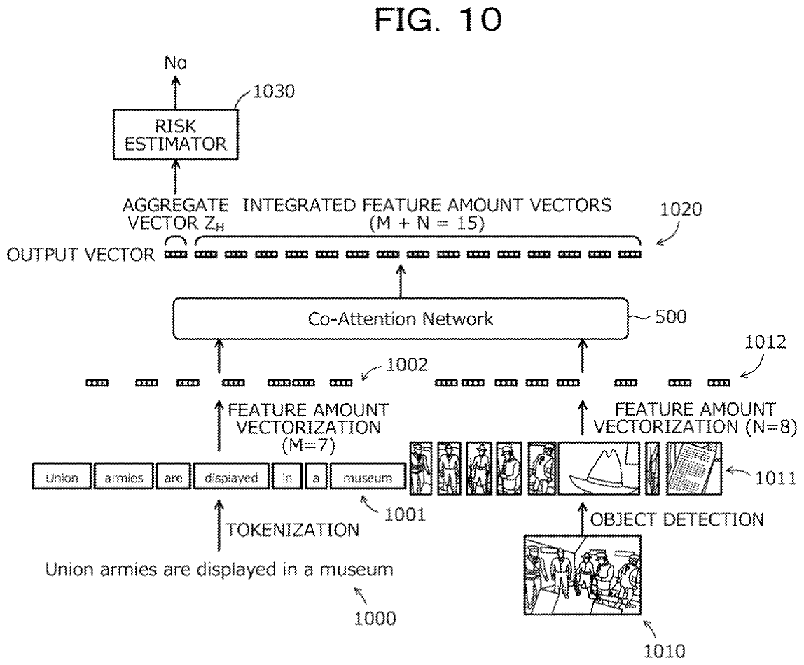

Here, a case where the image TA layer 501 is formed as in the specific examples illustrated in FIGS. 7 and 8 has been described, but the present embodiment is not limited to the examples. For example, there may also be a case where at least one of the image SA layer 502, the document TA layer 503, the document SA layer 504, or the integrated SA layer 506 is formed in a similar manner to the specific examples illustrated in FIGS. 7 and 8. Next, an example of an operation using the CAN500 by the output device 100 will be described with reference to FIG. 10.

FIG. 10 is an explanatory diagram illustrating an example of operation using the CAN500. In FIG. 10, the output device 100 acquires a document 1000 and an image 1010. The output device 100 tokenizes the document 1000, vectorizes a token set 1001, generates a feature amount vector 1002 for the document 1000, and inputs the feature amount vector 1002 to the CAN500. Furthermore, the output device 100 detects an object from the image 1010, vectorizes a set 1011 of partial images for each object, generates a feature amount vector 1012 related to the image 1010, and inputs the feature amount vector 1012 to the CAN500.

The output device 100 acquires the feature amount vector Z_{T} from the CAN500, and inputs the aggregate vector Z_{H} included in the feature amount vector Z_{T} to a risk estimator 1030. The output device 100 acquires an estimation result No from the risk estimator 1030. Thereby, the output device 100 may cause the risk estimator 1030 to estimate whether there is a risk using the aggregate vector Z_{H} in which the features of the image and the document are reflected, and enables accurate estimation as to whether there is a risk. For example, the risk estimator 1030 may estimate that the estimation result No is not risky because there is the image 1010 that captures a person with a gun but there is also the document informing that it is an exhibit in a museum.

### Use Example of Output Device 100

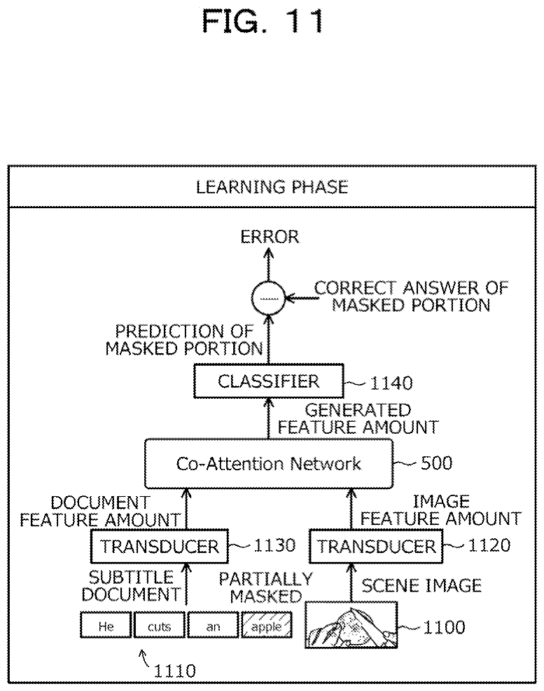

Next, a use example of the output device 100 will be described with reference to FIGS. 11 to 14.

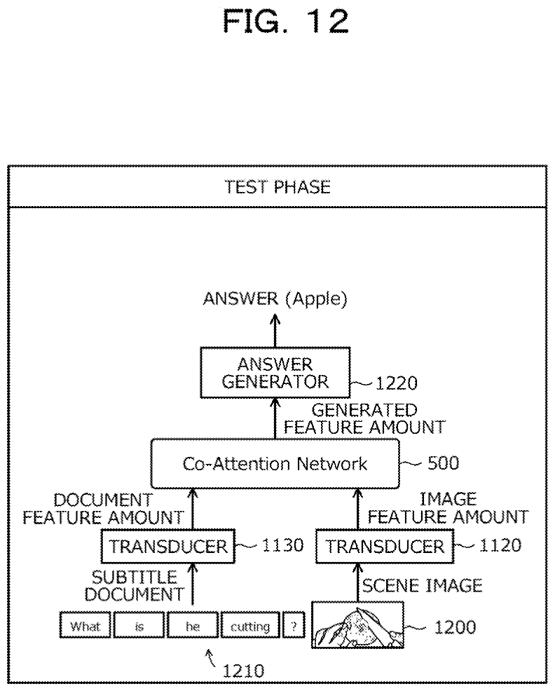

FIGS. 11 and 12 are explanatory diagrams illustrating a use example 1 of the output device 100. In FIG. 11, the output device 100 implements a learning phase and learns the CAN500. The output device 100 acquires, for example, an image 1100 capturing some scene and a document 1110 serving as subtitles corresponding to the image 1100. The image 1100 captures, for example, a scene of cutting an apple.

The output device 100 transforms the image 1100 into a feature amount vector by a transducer 1120 and inputs the feature amount vector to the CAN500. Furthermore, the output device 100 masks a word “apple” of the document 1110, then transforms the document 1110 into a feature amount vector by a transducer 1130, and inputs the feature amount vector to the CAN500.

The output device 100 inputs the feature amount vector generated by the CAN500 to a classifier 1140, acquires a result of predicting the masked word, and calculates an error from the correct answer “apple” of the masked word. The output device 100 learns the CAN500 by error back propagation on the basis of the calculated error. Moreover, the output device 100 may also learn the transducers 1120 and 1130 and the classifier 1140 by error back propagation.

Therefore, the output device 100 may update the CAN500, the transducers 1120 and 1130, and the classifier 1140 to be useful in terms of estimating words in consideration of the context of the image 1100 and the document 1110 serving as subtitles. Next, description proceeds to FIG. 12.

In FIG. 12, the output device 100 performs a test phase, and generates and outputs an answer using the learned transducers 1120 and 1130 and the learned CAN500. The output device 100 acquires, for example, an image 1200 capturing some scene and a document 1210 serving as a question sentence corresponding to the image 1200. The image 1200 captures, for example, a scene of cutting an apple.

The output device 100 transforms the image 1200 into a feature amount vector by a transducer 1120 and inputs the feature amount vector to the CAN500. Furthermore, the output device 100 transforms the document 1210 into a feature amount vector by the transducer 1130 and inputs the feature amount vector to the CAN500. The output device 100 inputs the feature amount vector generated by the CAN500 to an answer generator 1220, acquires a word to be an answer, and outputs the answer. Thereby, the output device 100 may accurately estimate the word to be an answer in consideration of the context of the image 1200 and the document 1210 as the question sentence.

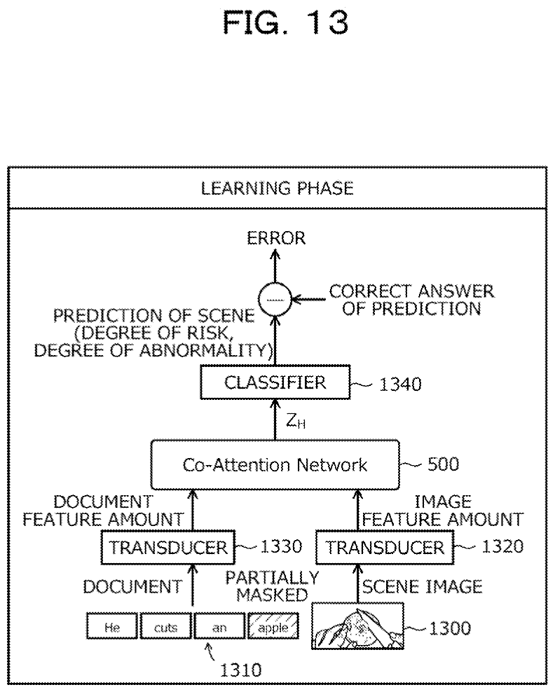

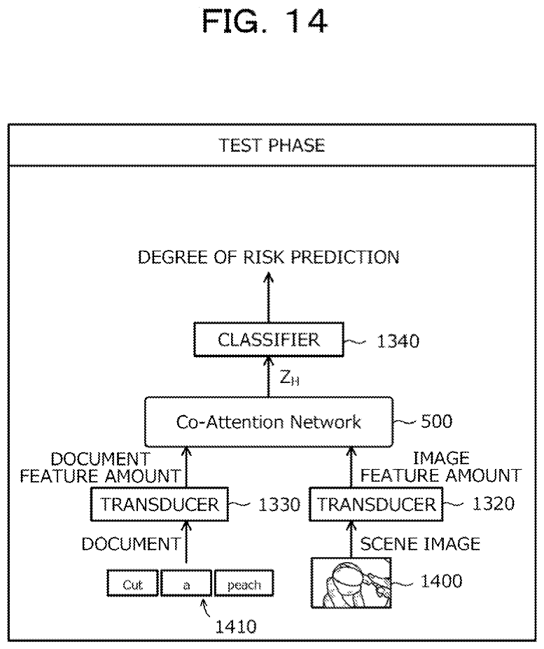

FIGS. 13 and 14 are explanatory diagrams illustrating a use example 2 of the output device 100. In FIG. 13, the output device 100 implements a learning phase and learns the CAN500. The output device 100 acquires, for example, an image 1300 capturing some scene and a document 1310 serving as subtitles corresponding to the image 1300. The image 1300 captures, for example, a scene of cutting an apple.

The output device 100 transforms the image 1300 into a feature amount vector by a transducer 1320 and inputs the feature amount vector to the CAN500. Furthermore, the output device 100 masks a word “apple” of the document 1310, then transforms the document 1310 into a feature amount vector by a transducer 1330, and inputs the feature amount vector to the CAN500.

The output device 100 inputs the feature amount vector generated by the CAN500 to a classifier 1340, acquires a result of predicting the degree of risk of the scene captured in the image, and calculates an error from the correct answer of the degree of risk. The output device 100 learns the CAN500 by error back propagation on the basis of the calculated error. Furthermore, the output device 100 learns the transducers 1320 and 1330 and the classifier 1340 by error back propagation.

Thereby, the output device 100 may update the CAN500, the transducers 1120 and 1130, and the classifier 1140 to be useful in terms of predicting the degree of risk in consideration of the context of the image 1300 and the document 1310 serving as subtitles. Next, description proceeds to FIG. 14.

In FIG. 14, the output device 100 performs a test phase, and predicts and outputs the degree of risk using the learned transducers 1320 and 1330 and classifier 1340, and the learned CAN500. The output device 100 acquires, for example, an image 1400 capturing some scene and a document 1410 serving as an explanatory text corresponding to the image. The image 1400 captures, for example, a scene of cutting a peach.

The output device 100 transforms the image 1400 into a feature amount vector by the transducer 1320 and inputs the feature amount vector to the CAN500. Furthermore, the output device 100 transforms the document 1410 into a feature amount vector by the transducer 1330 and inputs the feature amount vector to the CAN500. The output device 100 inputs the feature amount vector generated by the CAN500 to the classifier 1340, and acquires and outputs the degree of risk. Thereby, the output device 100 may accurately predict the degree of risk in consideration of the context of the image 1400 and the document 1410 serving as an explanatory text.

### (Learning Processing Procedure)

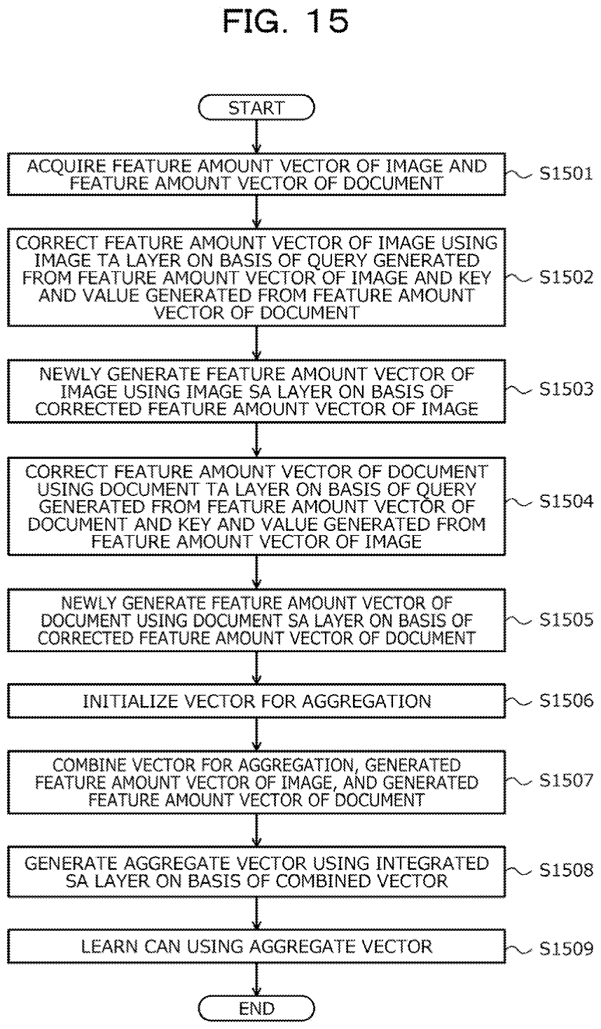

Next, an example of a learning processing procedure executed by the output device 100 will be described with reference to FIG. 15. The learning processing is implemented by, for example, the CPU 301, the storage area such as the memory 302 or the recording medium 305, and the network I/F 303 illustrated in FIG. 3.

FIG. 15 is a flowchart illustrating an example of a learning processing procedure. In FIG. 15, the output device 100 acquires the feature amount vector of an image and the feature amount vector of a document (step S1501).

Next, the output device 100 corrects the feature amount vector of the image using the image TA layer 501 on the basis of the query generated from the acquired feature amount vector of the image and the key and value generated from the acquired feature amount vector of the document (step S1502). Here, for example, the output device 100 corrects the feature amount vector of the image by executing attention processing to be described below in FIG. 14.

Then, the output device 100 further corrects the corrected feature amount vector of the image using the image SA layer 502 on the basis of the corrected feature amount vector of the image to newly generate the feature amount vector of the image (step S1503).

Next, the output device 100 corrects the feature amount vector of the document using the document TA layer 503 on the basis of the query generated from the acquired feature amount vector of the document and the key and value generated from the acquired feature amount vector of the image (step S1504).

Then, the output device 100 further corrects the corrected feature amount vector of the document using the document SA layer 504 on the basis of the corrected feature amount vector of the document to newly generate the feature amount vector of the document (step S1505).

Next, the output device 100 initializes the vector for aggregation (step S1506). Then, the output device 100 combines the vector for aggregation, the generated feature amount vector of the image, and the generated feature amount vector of the document to generate a combined vector (step S1507).

Next, the output device 100 corrects the combined vector to generate an aggregate vector using the integrated SA layer 506 on the basis of the combined vector (step S1508). Then, the output device 100 learns the CAN500 on the basis of the aggregate vector (step S1509).

Thereafter, the output device 100 terminates the learning processing. Thereby, the output device 100 may update the parameters of the CAN500 so that the accuracy of the solution when solving a problem is improved when solving the problem using the CAN500.

Here, the output device 100 may also execute the processing in some steps of FIG. 15 in a different order. For example, the processing in steps S1502 and S1503 and the processing in steps S1504 and S1505 may be switched in the order. Furthermore, the output device 100 may also repeatedly execute the processing in steps S1502 to S1505.

### (Estimation Processing Procedure)

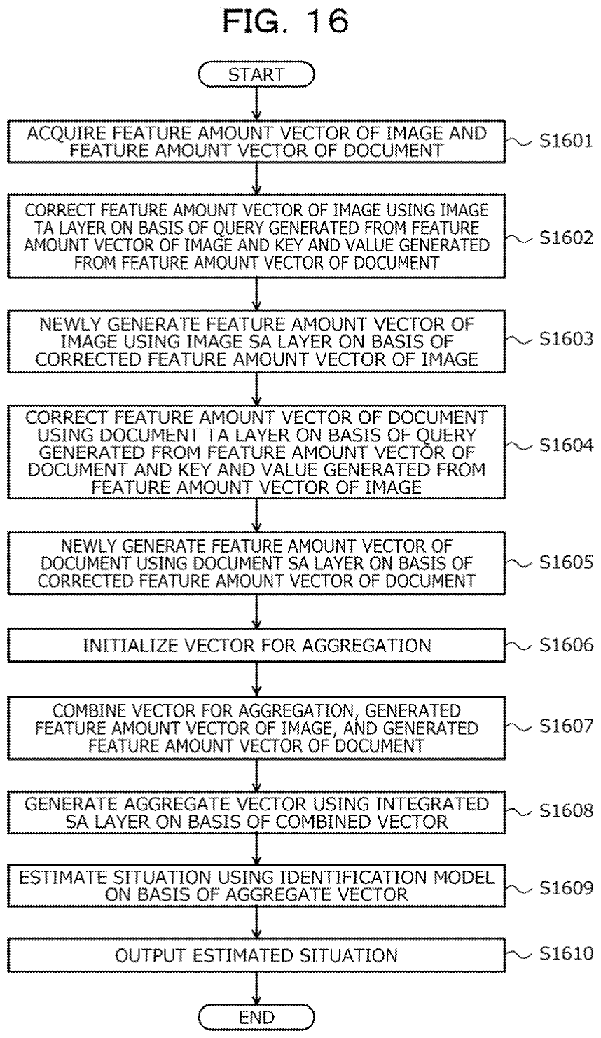

Next, an example of an estimation processing procedure executed by the output device 100 will be described with reference to FIG. 16. The estimation processing is implemented by, for example, the CPU 301, the storage area of the memory 302, the recording medium 305, or the like, and the network I/F 303 illustrated in FIG. 3.

FIG. 16 is a flowchart illustrating an example of an estimation processing procedure. In FIG. 16, the output device 100 acquires the feature amount vector of an image and the feature amount vector of a document (step S1601).

Next, the output device 100 corrects the feature amount vector of the image using the image TA layer 501 on the basis of the query generated from the acquired feature amount vector of the image and the key and value generated from the acquired feature amount vector of the document (step S1602). Here, for example, the output device 100 corrects the feature amount vector of the image by executing attention processing to be described below in FIG. 14.

Then, the output device 100 further corrects the corrected feature amount vector of the image using the image SA layer 502 on the basis of the corrected feature amount vector of the image to newly generate the feature amount vector of the image (step S1603).

Next, the output device 100 corrects the feature amount vector of the document using the document TA layer 503 on the basis of the query generated from the acquired feature amount vector of the document and the key and value generated from the acquired feature amount vector of the image (step S1604).

Then, the output device 100 further corrects the corrected feature amount vector of the document using the document SA layer 504 on the basis of the corrected feature amount vector of the document to newly generate the feature amount vector of the document (step S1605).

Next, the output device 100 initializes the vector for aggregation (step S1606). Then, the output device 100 combines the vector for aggregation, the generated feature amount vector of the image, and the generated feature amount vector of the document to generate a combined vector (step S1607).

Next, the output device 100 corrects the combined vector to generate an aggregate vector using the integrated SA layer 506 on the basis of the combined vector (step S1608). Then, the output device 100 estimates the situation using an identification model on the basis of the aggregate vector (step S1609).

Next, the output device 100 outputs the estimated situation (step S1610). Then, the output device 100 terminates the estimation processing. Thereby, the output device 100 may improve the accuracy of the solution when solving the problem using the CAN500.

Here, the output device 100 may also execute the processing in some steps of FIG. 16 in a different order. For example, the processing in steps S1602 and S1603 and the processing in steps S1604 and S1605 may be switched in the order. Furthermore, the output device 100 may also repeatedly execute the processing in steps S1602 to S1605.

### (Attention Processing Procedure)

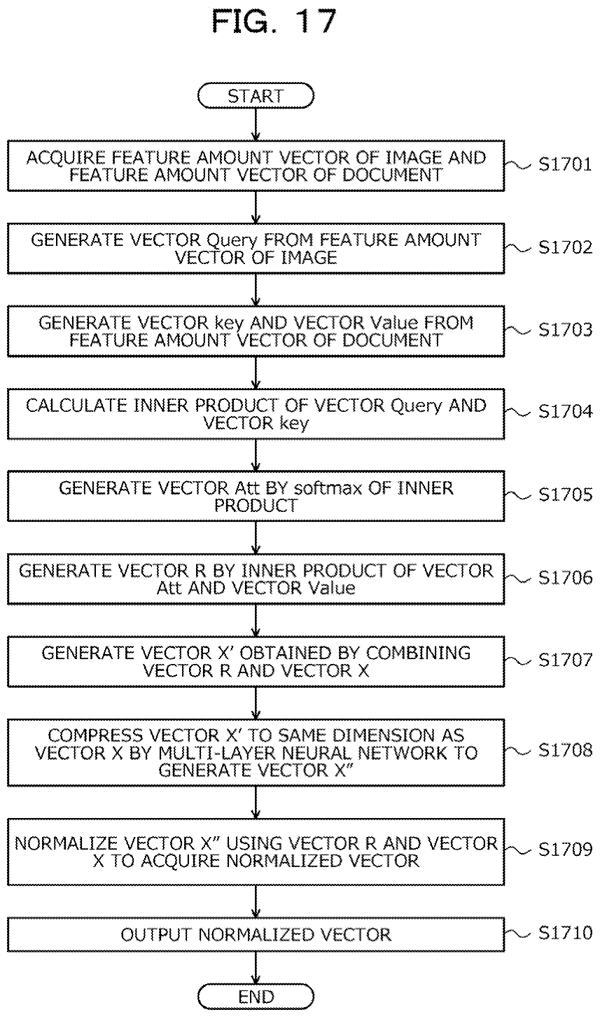

Next, an example of the attention processing procedure executed by the output device 100 using the image TA layer will be described with reference to FIG. 17. The attention processing is implemented by, for example, the CPU 301, the storage area such as the memory 302 or the recording medium 305, and the network I/F 303 illustrated in FIG. 3.

FIG. 17 is a flowchart illustrating an example of the attention processing procedure. In FIG. 17, the output device 100 acquires the feature amount vector of the image as the vector X and the feature amount vector of the document as the vector Y (step S1701).

Next, the output device 100 generates a vector Query from the acquired feature amount vector of the image (step S1702). Then, the output device 100 generates a vector key and a vector Value from the acquired feature amount vector of the document (step S1703).

Next, the output device 100 calculates the inner product of the generated vector Query and the generated vector key (step S1704). Then, the output device 100 generates a vector Att by softmax of the inner product (step S1705).

Next, the output device 100 generates a vector R by the inner product of the vector Att and the vector Value (step S1706). Then, the output device 100 generates a vector X′ obtained by combining the vector R and the vector X (step S1707).

Next, the output device 100 compresses the vector X′ to the same dimension as the vector X by the multi-layer neural network to generate a vector X″(step S1708). Then, the output device 100 normalizes the vector X″ using the vector R and the vector X to acquire a normalized vector (step S1709).

Next, the output device 100 outputs the acquired normalized vector (step S1710). Then, the output device 100 terminates the attention processing. Thereby, the output device 100 may generate and acquire the normalized vector so that the information useful for solving the problem in the image and the document is difficult to lose.

Here, the output device 100 may also execute the processing in some steps of FIG. 17 in a different order. For example, the processing in step S1702 and the processing in step S1703 may be switched in the order.

As described above, according to the output device 100, the correction vector for correcting the vector based on the information of the first modal may be generated on the basis of the correlation between the vector based on the information of the first modal and the vector based on the information of the second modal. According to the output device 100, the generated correction vector may be combined with the vector based on the information of the first modal. According to the output device 100, the combined vector based on the information of the first modal may be compressed according to a predetermined rule. According to the output device 100, the normalization processing may be performed for the compressed vector based on the information of the first modal. According to the output device 100, the vector obtained by the normalization processing may be output. Thereby, the output device 100 may leave the information useful for solving the problem in the vector based on the information of the first modal and the vector based on the information of the second modal and obtain the vector useful for solving the problem, and may make the accuracy of the solution when solving the problem improvable.

According to the output device 100, the correction vector may be generated on the basis of an inner product of a vector obtained from the vector based on the information of the first modal and a vector obtained from the vector based on the information of the second modal. Thereby, the output device 100 may implement the attention. Furthermore, the output device 100 may obtain the correction vector useful for solving the problem.

According to the output device 100, the sum of the vector based on the information of the first modal and the correction vector may be normalized, and the sum of the vector obtained by the corresponding normalization and the compressed vector based on the information of the first modal may be normalized. Thereby, the output device 100 may implement the normalization processing.

According to the output device 100, the sum of the combined vector based on the information of the first modal and the compressed vector based on the information of the first modal may be normalized. Thereby, the output device 100 may implement the normalization processing.

According to the output device 100, the modal related to an image may be adopted as the first modal. According to the output device 100, the modal related to a document may be adopted as the second modal. Thereby, the output device 100 may implement the target-attention layer. Furthermore, the output device 100 may be made applicable to a case of solving a problem on the basis of an image and a document.

According to the output device 100, the modal related to an image may be adopted as the first modal. According to the output device 100, the modal related to a voice may be adopted as the second modal. Thereby, the output device 100 may implement the target-attention layer. Furthermore, the output device 100 may be made applicable to a case of solving a problem on the basis of an image and a voice.

According to the output device 100, the modal related to a document in the first language may be adopted as the first modal. According to the output device 100, the modal related to a document in the second language may be adopted as the second modal. Thereby, the output device 100 may implement the target-attention layer. Furthermore, the output device 100 may be made applicable to a case of solving a problem on the basis of two documents in different languages.

According to the output device 100, the same modal may be adopted for the first modal and the second modal. Thereby, the output device 100 may implement the self-attention layer. Furthermore, the output device 100 may be made applicable to a case of solving a problem on the basis of different pieces of information of the same modal.

Note that the method for outputting described in the present embodiment may be implemented by executing a prepared program on a computer such as a PC or a workstation. The output program described in the present embodiment is executed by being recorded on a computer-readable recording medium and being read from the recording medium by the computer. The recording medium is a hard disk, a flexible disk, a compact disc read only memory (CD-ROM), a magneto-optical disc (MO), a digital versatile disc (DVD), or the like. Furthermore, the output program described in the present embodiment may also be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-implemented outputting method comprising:
generating a correction vector that corrects a vector based on information of a first modal on the basis of correlation between the vector based on the information of the first modal and a vector based on information of a second modal;
combining the generated correction vector with the vector based on the information of the first modal;
compressing the combined vector based on the information of the first modal according to a predetermined rule;
performing normalization processing for the compressed vector based on the information of the first modal; and
outputting a vector obtained by the normalization processing.

2. The method according to claim 1, wherein the generating includes
generating the correction vector on the basis of an inner product of a vector obtained from the vector based on the information of the first modal and a vector obtained from the vector based on the information of the second modal.

3. The method according to claim 1, wherein the performing of the normalization processing includes
normalizing a sum of the vector based on the information of the first modal and the correction vector, and
normalizing a sum of the vector obtained by the corresponding normalization and the compressed vector based on the information of the first modal.

4. The method according to claim 1, wherein the performing of the normalization processing includes
normalizing a sum of the combined vector based on the information of the first modal and the compressed vector based on the information of the first modal.

5. The method according to claim 1, wherein a set of the first modal and the second modal is one of a set of a modal related to an image and a modal related to a document, a set of a modal related to an image and a modal related to a voice, or a set of a modal related to a document in a first language and a modal related to a document in a second language.

6. The method according to claim 1, wherein the first modal is same as the second modal.

7. A non-transitory computer-readable storage medium storing a program for causing a computer to perform processing, the processing comprising:
generating a correction vector that corrects a vector based on information of a first modal on the basis of correlation between the vector based on the information of the first modal and a vector based on information of a second modal;
combining the generated correction vector with the vector based on the information of the first modal;
compressing the combined vector based on the information of the first modal according to a predetermined rule;
performing normalization processing for the compressed vector based on the information of the first modal; and
outputting a vector obtained by the normalization processing.

8. An outputting apparatus comprising:
a memory; and
a processor coupled to the memory, the processor being configured to perform processing, the processing including:
generating a correction vector that corrects a vector based on information of a first modal on the basis of correlation between the vector based on the information of the first modal and a vector based on information of a second modal;
combining the generated correction vector with the vector based on the information of the first modal;
compressing the combined vector based on the information of the first modal according to a predetermined rule;
performing normalization processing for the compressed vector based on the information of the first modal; and
outputting a vector obtained by the normalization processing.
